(19) United States
(12) Patent Application Publication
(10) Pub. No.: US 2014/0049937 A1
(43) Pub. Date: Feb. 20, 2014

(54) Skye flash

(71) Applicant: Cody Skye Buckner, Riverdale, GA (US)

(72) Inventor: Cody Skye Buckner, Riverdale, GA (US)

(21) Appl. No.: 13/987,539

(22) Filed: Aug. 6, 2013

Related U.S. Application Data
(60) Provisional application No. 61/742,650, filed on Aug. 16, 2012.

(51) Int. Cl. G03B 15/02

(52) U.S. Cl. CPC G03B 15/02
USPC 362/3

(57) ABSTRACT

A flash unit(s) include a flash device(s) operable to emit a flash. The flash can be of any type. The flash will be attached to the front face (front side) of the electronic device. The electronic device can be of any type. The unit(s) can be placed on either side of the device, meaning the right, left and/or both. It can also be placed in the center of the device. This will assist the user in obtaining a higher quality picture and/or video.

### FOREIGN APPLICATION PRIORITY DATA

Foreign filing license granted Sep. 11, 2012

Paris Convention: U.S. 61/742,650

### REFERENCES

U.S. Pat. No. 8,249,442

Yasuda, et al. Aug. 21, 2012

Nonprovisional (utility) Patent Application Filing Guide

http://www.uspto.gov/patents/resources/types/utility.isp

### U.S. PATENT DOCUMENTS

### Summary

A flash unit(s) include a flash device(s) operable to emit a flash. The flash can be of any type. The flash will be attached to the front face (front side) of the electronic device. The electronic device can be of any type. The unit(s) can be placed on either side of the device, meaning the right, left and/or both. It can also be placed in the center of the device. This will assist the user in obtaining a higher quality picture and/or video.

Inventor: Cody Skye Buckner

Application No.: 61/742,650

Filed: Aug. 16, 2012
1) A flash unit(s) include a flash device(s) operable to emit a flash. The flash can be of any type. The flash will be attached to the front face (front side) of the electronic device. The electronic device can be of any type. The unit(s) can be placed on either side of the device, meaning right, left and/or both. It can also be placed in the center of the electronic device. This will assist the user in obtaining a higher quality picture and/or video. The name will be Skye Flash.
2) The flash unit(s) according to claim 1, inserting a small flash of any type into the front face (front side) of the electronic device.
3) The flash unit(s) according to claim 2. The flash will be inserted into the front face (front side) of the electronic device, this will assist the user in obtaining a higher quality picture and/or video.
4) The flash unit(s) according to claim 3. The flash unit(s) can be placed on either side of the electronic device, meaning the right, left and/or both. The unit(s) can also be placed in the center of the device.

### DRAWINGS

### Brief Description of Drawings

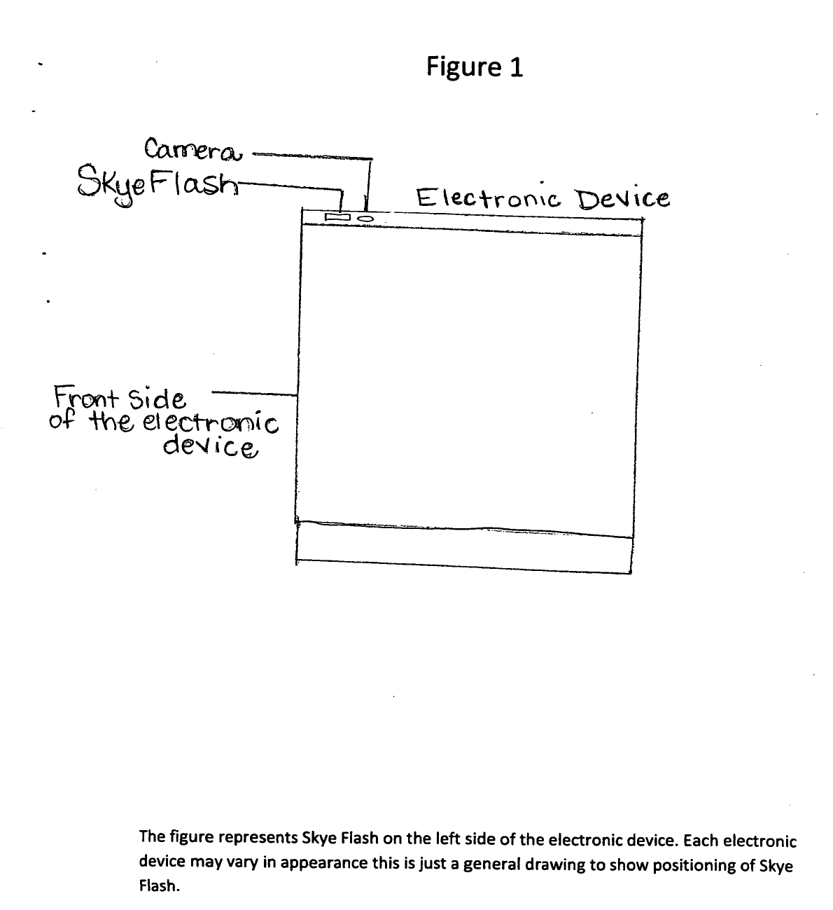

1) FIG. 1 is the Skye Flash on the left side of the electronic device. Each electronic device may vary in appearance this is just a general drawing to show positioning of the Skye Flash.

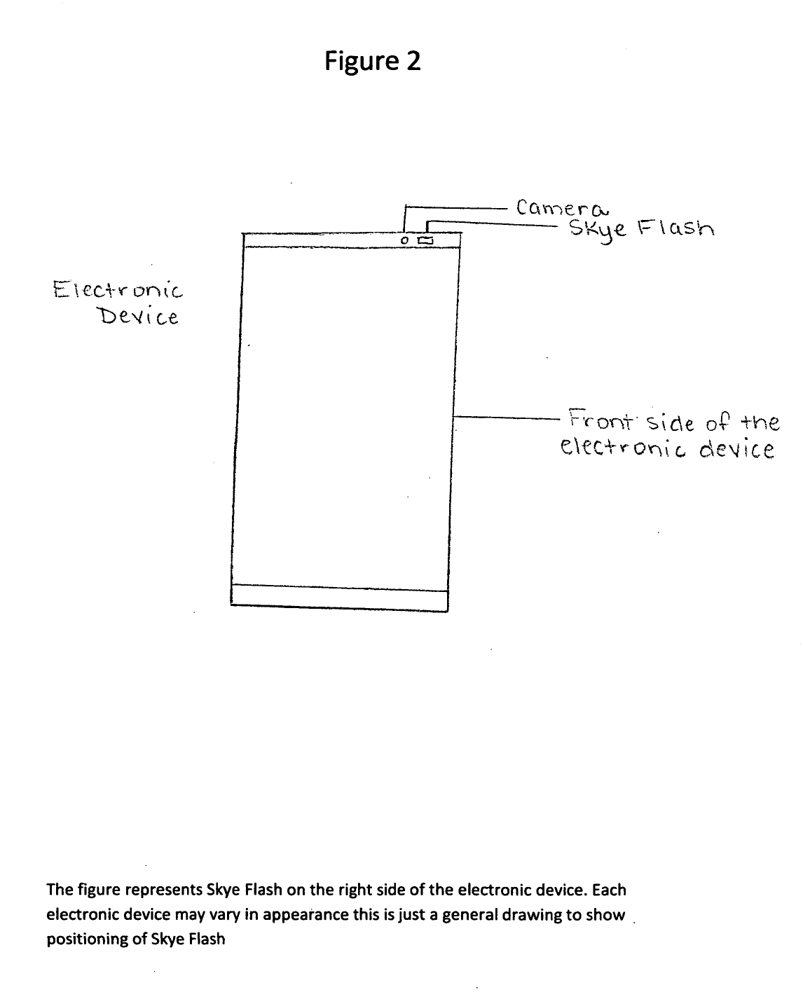

2) FIG. 2 is the Skye Flash on the right side of the electronic device. Each electronic device may vary In appearance this is just a general drawing to show positioning of Skye Flash.

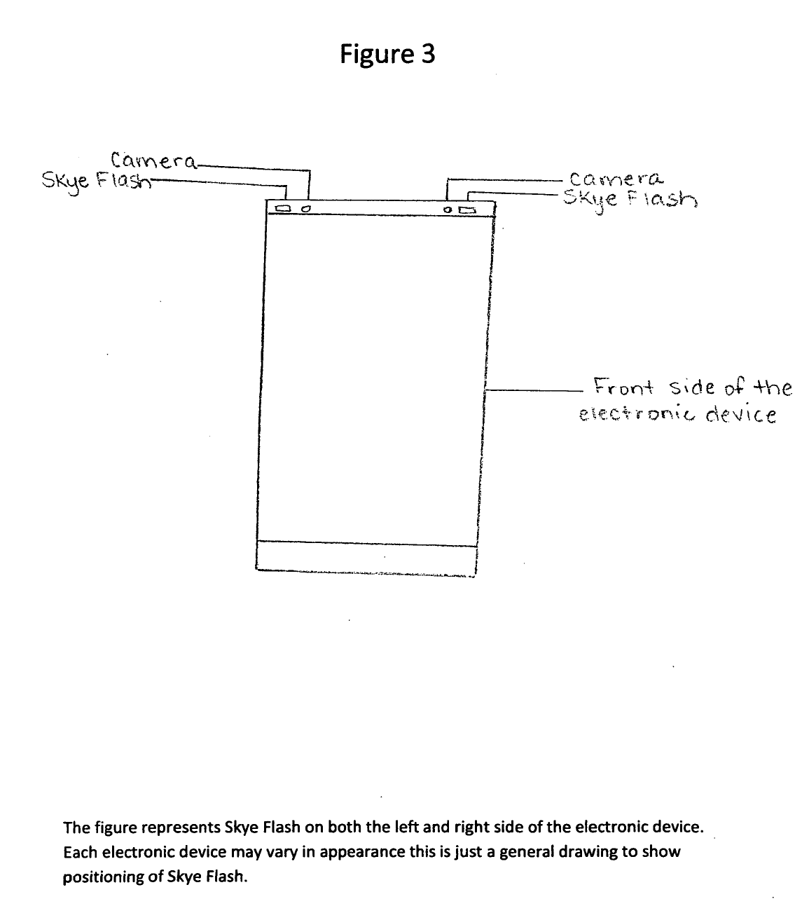

3) FIG. 3 is the Skye Flash on both the left and right side of the electronic device. Each electronic device may vary in appearance this is just a general drawing to show positioning of the Skye Flash.

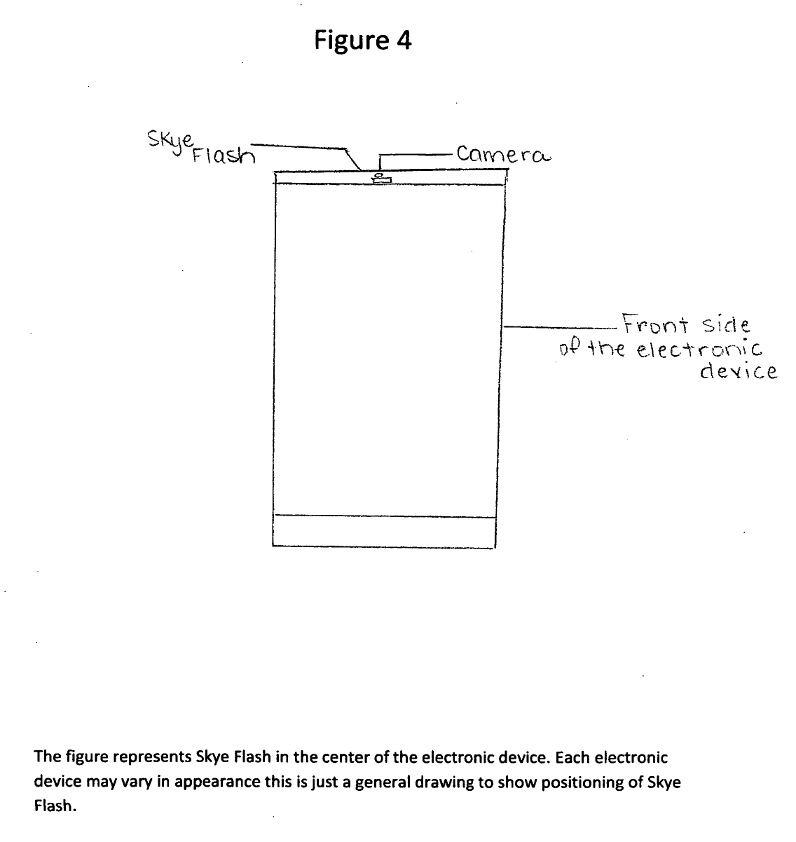

4) FIG. 4 is the Skye Flash in the center of the electronic device. Each electronic device may vary in appearance this is just a general drawing to show the positioning of Skye Flash.

### INDUSTRIAL APPLICABILITY

A flash unit(s) can be applied not only to camera equipped cellular phones, computer tablets, digital/film cameras, computers, all electronic devices, and the like.

1) A flash unit(s) include a flash device(s) operable to emit a flash. The flash can be of any type. The flash will be attached to the front face (front side) of the electronic device. The electronic device can be of any type. The unit(s) can be placed on either side of the device, meaning right, left and/or both. It can also be placed in the center of the electronic device. This will assist the user in obtaining a higher quality picture and/or video. The name will be Skye Flash.

2) The flash unit(s) according to claim 1, inserting a small flash of any type into the front face (front side) of the electronic device.

3) The flash unit(s) according to claim 2. The flash will be inserted into the front face (front side) of the electronic device, this will assist the user in obtaining a higher quality picture and/or video.

4) The flash unit(s) according to claim 3. The flash unit(s) can be placed on either side of the electronic device, meaning the right, left and/or both. The unit(s) can also be placed in the center of the device.
